(19) United States
(12) Patent Application Publication
(10) Pub. No.: US 2020/0213383 A1
(43) Pub. Date: Jul. 2, 2020

(54) METHODS AND SYSTEMS FOR REMOTELY EXECUTING, OR FACILITATING THE EXECUTING OF, SECURITY COMMANDS

(71) Applicant: DiDi Research America, LLC, Mountain View, CA (US)

(72) Inventors: Chandrasekhar Rentachintala, Mountain View, CA (US); Mahesh Pisal, Mountain View, CA (US); Yifan Jin, Mountain View, CA (US); Qingdi Liu, Mountain View, CA (US)

(21) Appl. No.: 16/236,731

(22) Filed: Dec. 31, 2018

(51) Int. Cl. H04L 29/08; H04L 29/06

(52) U.S. Cl. CPC H04L 67/025; H04L 67/34; H04L 67/42; G06F 9/451; H04L 67/143; H04L 63/08; H04L 63/102; H04L 67/141

(57) ABSTRACT

Methods and systems for remotely executing or communicating messages or commands such as security commands, or facilitating the execution or communication of such messages or commands, are disclosed herein. In one example embodiment, such a system or method can include an agent application installed on a client device directing the client device to periodically check a server for a new command request for the client device, the client device downloading the new command request from the server, and the client device executing the new command request. Also, in an additional example embodiment, the new command request can direct the client device to set up a command session between the server and the client device and, responsive to executing the new command request, the client device can set up the command session with the server.

### CROSS-REFERENCE TO RELATED APPLICATIONS

### STATEMENT REGARDING FEDERALLY SPONSORED RESEARCH OR DEVELOPMENT

### FIELD

The present invention relates generally to systems such as device management systems in which there are communications among various computer devices or systems, such as among a server and one or more client devices, and methods of communication employed by or in relation to such systems. More particularly, the present invention relates to methods and systems for remotely executing or communicating messages or commands such as security commands, or facilitating the execution or communication of such messages or commands, on or in relation to device management systems or similar systems.

### BACKGROUND

Device management systems including a server and one or more client devices are known in the art. However, such known systems do not include efficient and security focused methods for transmitting security commands from the server to a client device for execution thereon. Specifically, known solutions require a large amount of connection overhead on the server and do not provide adequate procedures for monitoring, governing, or enforcing interactions with client devices.

Therefore, it would be advantageous if one or more new or improved methods or systems for communicating or executing commands or other messages, or for facilitating the execution or communication of commands or other messages, could be developed that largely or entirely overcame one or more of the aforementioned limitations associated with conventional solutions in the context of systems such as device management systems, and/or avoided or overcame one or more other disadvantages, and/or provided one or more other advantages.

### SUMMARY

In at least some example embodiments encompassed herein, the present disclosure relates to a method. The method includes directing a client device to periodically check a server for a new command request for the client device, by way of an agent application installed on a client device. Additionally, the method also includes downloading, at the client device, a new command request for the client device from the server, and executing the new command request at the client device. Further, in some such example embodiments, the new command request can direct the client device to set up a command session between the server and the client device and, responsive to executing the new command request, the client device can set up the command session with the server.

In at least some additional example embodiments encompassed herein, the present disclosure relates to a system. The system includes a client device and a server, where an agent application installed on the client device directs the client device to periodically check the server for a new command request for the client device, and the client device downloads the new command request for the client device from the server and executes the new command request.

In at least some further example embodiments encompassed herein, the present disclosure relates to a method. The method includes a server storing a new command for a client device, the server receiving a request for the new command from the client device and, responsive to the request, the server transmitting the new command to the client device. The method also includes, responsive to transmitting the new command to the client device, the server receiving access to a command session with the client device, and the server receiving access credentials, a selection of an indicator of the command session, and a security command from a user interface device. Additionally, the method includes, responsive to the selection of the indicator of the command session and the server determining that the access credentials allow the user interface device to access the client device, the server forwarding the security command to the client device using the command session. Further, the method includes the server receiving a result of the security command from the client device, the server forwarding the result of the security command to the user interface device, and the server terminating the command session.

### BRIEF DESCRIPTION OF THE DRAWINGS

FIG. 1 is a block diagram of a system in accordance with an example embodiment encompassed herein;

FIG. 2 is an additional block diagram showing in more detail portions of the system of FIG. 1; and

FIG. 3 is a flow diagram of a method that can be performed by the system of FIG. 1 in accordance with an example embodiment encompassed herein.

### DETAILED DESCRIPTION

The present disclosure relates, in at least some embodiments, to systems and methods for remotely executing security commands on a client device. In at least some embodiments disclosed herein, such systems and methods can include an agent application installed on the client device directing the client device to periodically check a server for a new command request for the client device. When the client device finds a new command request on the server, the client device can download the new command request for the client device from the server and can execute the new command request.

Also in at least some embodiments, the new command request can direct the client device and/or the agent application running on the client device to set up or initiate a two-way web socket channel or command session between the server and the client device. In some such embodiments, the client device and/or the agent application running on the client device can set-up or initiate the command session transparently from a user of the client device. Additionally or alternatively, in some embodiments, the client device and/or the agent application running on the client device can solicit user input from the user of the client device agreeing or disagreeing to set-up or initiate the command session. In response to executing the new command request, the client device additionally can set-up or initiate the command session with the server transparently from the user of the client device, or can solicit the user input and set-up or initiate the command session when the user input agrees to set-up and initiate the command session.

In some such embodiments where the new command request directs the client device and/or the agent application running on the client device to set up or initiate the command session, the command session can be used to transmit security commands from the server and/or a user interface device of the server to the client device for execution thereon. Such security commands can include, but are not limited to, security command instructions to record some or all operations of the client device, disable some or all of the operations of the client device, and/or transmit a record of some or all of the operations of the client device to the server and/or the user interface device.

Further, in some such embodiments, the agent application can open or initiate a universal runtime environment on the client device for executing the new command request. In some embodiments, the agent application can open or initiate the universal runtime environment transparently from the user of the client device. In such embodiments where the new command request will be executed within the universal runtime environment of the client device, the new command request can include security command instructions to record some or all operations of the client device, disable some or all of the operations of the client device, and/or transmit a record of some or all of the operations of the client device to the server.

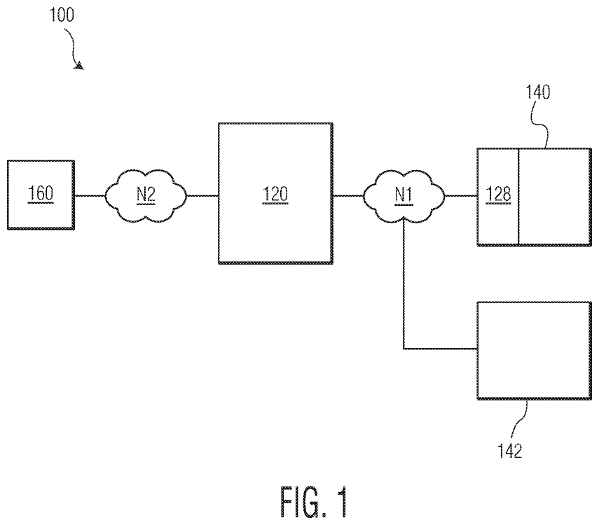

FIG. 1 is a block diagram of a system 100 that is in accordance with one example embodiment encompassed herein. As shown in FIG. 1, in the present embodiment, the system 100 can include a server 120, a client device 140 that can connect to and be in communication with the server 120 over a network N1, and a user interface device 160 that can connect to and be in communication with the server 120 over a network N2. Additionally as shown, the client device 140 can include an agent application 128 running on a processor of the client device and used to facilitate communication between the server 120 and/or the user interface device 160.

It should be appreciated that the server 120 is able to communicate with more than one client device and often will be configured for and in communication with many client devices (e.g., hundreds or more). Accordingly, the system 100 also is shown to include a second, additional client device 142 that also can connect to and be in communication with the server 120 via the network N1. Further in this regard, it should be understood that the presence of the additional client device 142 in FIG. 1 is intended to be representative of the possible presence of any arbitrary number of one or more client device(s) in the system 100 (including an embodiment or circumstance in which only a single client device, such as the client device 140, is present in the system).

In view of the above description, it will be appreciated that the system 100 takes the form of a client-server system in which the client devices 140 and 142 are coupled to and in communication with the server 120. Accordingly, each of the client devices 140, 142 generally is respectively configured to engage in communications with the server 120 by which the respective client devices contact the server to obtain information, data, or services, and the server can respond to those requests, including by providing information, data, or services to the respective client devices making the respective requests. The server 120 can be understood to include or take the form of a server computer system or device that operates in accordance with programming allowing the server to respond to requests from, provided services to, and otherwise interact with, client devices such as the client devices 140 and 142. Although illustrated as a single structure, it should be understood that the server 120 can be provided by way of, or include or take the form of, one or more server computers (e.g., multiple computers or a distributed system).

In the present embodiment, the computer system 100 particularly can be considered a security operations center (SOC) computer system. As will be described in further detail, the server 120 in the present embodiment particularly can include software or programming allowing the server computer to serve as a security agent backend server. Further, each of the client devices 140 and 142 can be computers having security agent software or programming provided thereon, such as the agent application 128, and accordingly can be considered agent computers. The client devices 140, 142 further can be considered or referred to as endpoint devices. Each of the client devices 140, 142 can include, but is not limited to, a personal computing device, a mobile phone, a tablet, and a vehicle mounted processor, among others.

As mentioned above, the user interface device 160 also is in communication with the server 120. In the present embodiment of the system 100, in which the system 100 is a SOC computer system, the user interface device 160 can access and control security operations systems on the server 120 that access and control backend operations of the server 120. Thus, although shown in FIG. 1 as being distinct from and coupled to the server 120 by way of the network N2, the user interface device 160 can be considered to be part of, or to be integrated with the server 120. Indeed, the user interface device 160 can be considered part of a server operation system that also encompasses the server 120. The user interface device 160 can include, for example, a remote terminal connected to the server 120 (e.g., a personal computing device, a mobile phone, and a tablet, among others). Although not shown in FIG. 1, it should be appreciated that, in other embodiments, one or more additional user interface devices in addition to the user interface device 160 can also be present as part of the system 100 and be coupled to and in communication with the server 120 (for example, also by way of the network N2).

The networks N1 and N2 of FIG. 1 are intended to representative of any of a variety of wireless and/or wired networks or communication links. The networks N1 and N2 can be two different types of networks or communication links, or be of the same type. Although shown to be two distinct networks or communication links in FIG. 1, the networks N1 and N2 can also be, or share in common, one or more network portions or communication link(s). More particularly, either or both of the networks N1 and N2 can take the form of, or include, an intranet or private network, or one or more proprietary communication links. For example, to the extent that the user interface device 160 is integrated with the server 120 the network N2 can take the form of a direct bus connection. Also for example, one or both of the networks N1 and N2 can be part of the Internet (or, alternatively, the World Wide Web).

Also for example, either of both of the networks N1 and N2 can employ any of a variety of networks, communication links, or associated technologies including, for example, a cellular network, a local area network (LAN), a wide area network (WAN), a wireless local area network (WLAN), Wi-Fi communication links or access points, a metropolitan area network (MAN), a public telephone switched network (PSTN), a Bluetooth network, a ZigBee network, a near field communication (NFC) network, a cable network, a wireline network, an optical fiber network, a telecommunications network or the like, or any combination thereof.

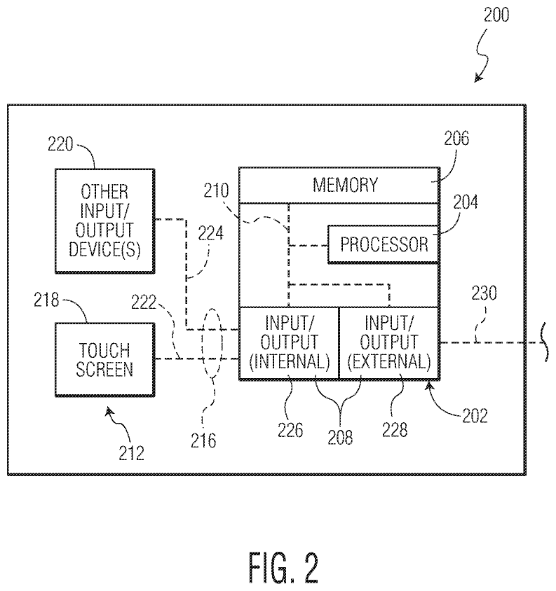

Turning to FIG. 2, a block diagram is provided to illustrate example components of a computer 200. It should be appreciated that, in at least some embodiments, each of the server 120 (or the server computer operating as the server 120), the client devices 140 and 142, and the user interface device 160 can take the form of the computer 200. That is, the computer 200 is intended to be representative of at least one embodiment of each of the server 120, the client devices 140 and 142, and the user interface device 160. Again, however, it should be appreciated that the computer 200 is merely an example computer and the components shown as being included in the computer 200 are merely example components.

In the representation of FIG. 2, the computer 200 is shown to have a central portion 202 that includes each of a processor 204, a memory 206, and one or more input/output port(s) 208. Each of the processor 204, the memory 206, and the one or more input/output port(s) 208 are in communication with one another, directly or indirectly, by way of one or more internal communication link(s) 210, which can include wired or wireless links depending upon the embodiment. In at least some such embodiments, the internal communication link(s) 210 can take the form of a bus.

More particularly with respect to the processor 204, it should be appreciated that the processor 204 is intended to be representative of the presence of any one or more processors or processing devices, of any of a variety of forms. For example, the processor 204 is intended to be representative of any one or more of a microprocessor, a central processing unit (CPU), a controller, a microcontroller unit, an application-specific integrated circuit (ASIC), an application-specific instruction-set processor (ASIP), a graphics processing unit (GPU), a digital signal processor (DSP), a field programmable gate array (FPGA), a programmable logic device (PLD), a physics processing unit (PPU), a reduced instruction-set computer (RISC), or the like, or any combination thereof. The processor 204 can be configured to execute program instructions including, for example, instructions provided via software, firmware, operating systems, applications, or programs, and can be configured for performing any of a variety of processing, computational, control, or monitoring functions.

Further, the memory 206 of FIG. 2 is intended to be representative of the presence of any one or more memory or storage devices, which can be employed to store or record computer program instructions (e.g., those of an operating system or application), data, or information of any of a variety of types. In accordance with the present disclosure, such memory or storage devices can particularly be employed to store any of a variety of types of software programming, applications, operating systems, data, or other information. Depending upon the embodiment, the memory 206 can include any one or more of a variety of types of devices or components (or systems) or forms of computer-readable media such as, for example, mass storage devices, removable storage devices, hard drives, magnetic disks, optical disks, solid-state drives, floppy disks, flash drives, optical disks, memory cards, zip disks, magnetic tape, volatile read-and-write memory, random access memory (RAM) (e.g., dynamic RAM (DRAM) or static RAM (SRAM), etc.), or read-only memory (ROM) (e.g., erasable or electrically-erasable programmable ROM (EPROM or EEPROM), etc.).

Although the computer 200 is shown in FIG. 2 as including the memory 206 as part of the computer, the present disclosure is also intended to encompass embodiments in which the memory 206 operates in combination with, or is replaced by, one or more remote memory devices. Such remote memory devices can include, for example, a cloud platform such as a public or private cloud. Further, even though the computer 200 is shown as including the processor 204, in other embodiments the computer can also communicate and interact with remote processing devices that can provide additional computational or other processing resources. Also, in some embodiments, the memory 206 and processor 204 can be integrated in a single device (e.g., a processor-in-memory (PIM)).

Additionally, in the representation provided in FIG. 2, the computer 200 is shown to include input/output devices 212 that are coupled to, for communication with, the central portion 202 by way of communication link(s) 216. In the present example embodiment, the input/output devices 212 include a touch screen 218 and one or more other input/output devices 220, and the communication links 216 include a first link 222 coupling the touch screen 218 with the central portion 202 and a second link 224 coupling the one or more other input/output devices 220 with the central portion. However, the input/output devices 212 shown in FIG. 2 are merely intended to serve as examples, and the present disclosure is intended to encompass numerous other embodiments of computers having any of a variety of different types, and numbers, of input/output devices including, for example, a keyboard, a mouse, a speaker, a microphone, or a monitor or other display, a temperature sensor, a vibration device, etc.

Further with respect to FIG. 2, the input/output ports 208 are shown to include each of internal input/output ports 226, by which the central portion 202 of the computer 200 is coupled to the input/output devices 212, as well as external input/output ports 228, which permit or facilitate communications between the computer 200 and one or more computers, computer systems, computer system components (not shown in FIG. 2). The internal input/output ports 226 particularly can be coupled to the input/output devices 212 by way of the communication links 216. Also, the external input/output ports 228 permit or facilitate communications between the computer 200 and other systems or devices (including remotely-located systems or devices) by way of one or more communication links 230, which can be wireless or wired communication links.

For example, if one supposes that the computer 200 is one of the client devices 140 or 142, or the user interface device 160, the external input/output ports 228 can allow for and facilitate communications between the computer 200 and the server 120 (or vice versa) by way of the communication networks N1 or N2 described above in regard to FIG. 1, which in such example can constitute one or more of the communication links 230. Also for example, if one supposes that the computer 200 is the server 120 (or the server computer operating as the server 120), the external input/output ports 228 can allow for and facilitate communications between the computer 200 and the client devices 140, 142 or the user interface device 160 by way of the communication network N1 or N2 described above in regard to FIG. 1, which in such example can constitute one or more of the communication links 230.

It should be appreciated that the external input/output ports 228 can include, depending upon the embodiment, one or more devices, such as one or more wireless transceivers or transponders, by which wireless communications can occur between the computer 200 and remote computer, computer systems, or computer system components, or other remote systems or devices, via the communication link(s) 230. Also, each of the internal input/output ports 226 and the external input/output ports 228 can be configured to suit the particular systems or devices with which those input/output devices are intended to communicate, and/or the communication link(s) by which such communication will take place. For example, the number and configuration of the internal input/output ports 226 can be suited to allow for appropriate communications between the central portion 202 and the input/output devices 212 that are particularly coupled to those internal input/output ports.

It should be appreciated that the computer 200 can take the form of, or be considered, a general purpose computer or a special purpose computer depending upon the embodiment. It can take any of a variety of forms including, for example, a personal computer, a desktop computer, or a user terminal, as well as any of a variety of types of mobile devices such as a smart phone, laptop computer, a tablet, a wearable, a personal digital assistant (PDA), etc. Although in one embodiment the computer system 100 can be a security operations center computer system, which for example can be associated with a facility or enterprise, the present disclosure is intended to encompass computer systems that are, or that include one or more computers that are, provided or supported in vehicles or other systems.

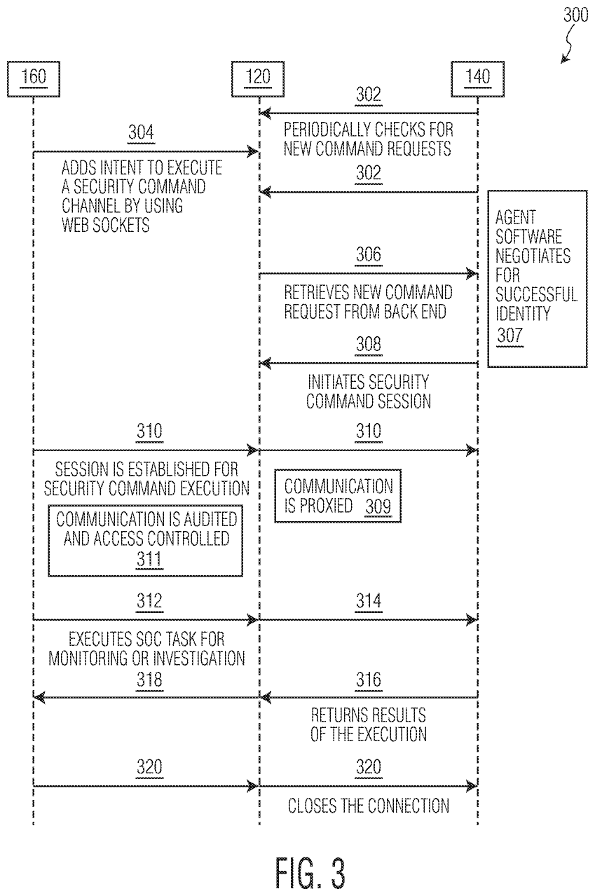

Turning to FIG. 3, a flow diagram is provided showing a method 300 of operation that can be performed by the system 100 of FIG. 1, in accordance with an example embodiment encompassed herein. The flow diagram particularly illustrates the method 300 as including steps that are performed by or at each of the user interface device 160, the server 120, and the client device 140 of the system 100 of FIG. 1. Nevertheless, it should be recognized that the method 300 can also be performed by the user interface device 160, the server 120, the additional client device 142 (or possibly any of a number or other client devices that can be coupled to, and in communication with the server 120), or in a manner involving other computers or other devices (e.g., another interface device). Also, it should be recognized that the method 300 can be performed repeatedly, and/or simultaneously (or substantially simultaneously), by the server 120 in combination with multiple different ones of the client devices and/or user interface devices depending upon the embodiment or implementation.

As shown in FIG. 3, the method 300 can begin with the client device 140 periodically checking the server 120 for a new command request associated with the client device 140, as in a step 302. In some embodiments, the agent application 128 can direct the client device 140 to check the server 120 for the new command request. Also, in some embodiments, the client device 140 can check the server 120 at pre-configured time intervals. FIG. 3 shows the step 302 as occurring on multiple (e.g., two) occasions as an indication that the client device 140 can and typically does check with the server 120 repeatedly, on multiple occasions, particularly until such time as a new command request has become available at the server 120.

Further with reference to FIG. 3, at some time, a new command request will become available at the server 120. More particularly, in the present embodiment, the server 120 at some time receives a new command request from the user interface device, as in a step 304. Additionally, in some embodiments or implementations, the server 120 can store the new command request in a folder or database location unique to the client device 140 (as opposed to a folder or database location for another client device, such as the client device 142). Alternatively, in some embodiments, the server 120 can store the new command request within a global database on a memory device with an entry that cross references the new command request with the client device 140.

When the client device 140 periodically checks the server 120 for the new command as in the step 302, and a new command request has now become available at the server 120 as in the step 304, then at a step 306 the client device 140 retrieves the new command request from the server 120 (e.g., from the security agent backend server). If the new command request was stored by the server 120 as described above, in a unique folder or database location, or in a global database, the server 120 can retrieve the new command request from the unique folder or database or from the global database using the cross-referencing entry and can transmit the new command request to the client device, at the step 306.

Further, when the client device 140 receives the new command request from the server 120, the client device can execute the new command request at a step 308. In the present example embodiment, the new command request received by the client device 140 can direct the client device 140 and/or the agent application 128 to set up a command session (or web socket channel) between the server 120 and the client device 140. In response to receiving such a new command request, the client device 140 can execute the new command request at the step 308 by taking action to initiate the establishment of such a command session (e.g., a security command session) with the server 120. In some embodiments, as described herein, the command session can be set up transparently from a user of the client device 140. Also, as further represented by a block 307, this process can involve negotiations by which the client device 140 (or associate agent software) negotiates for a successful identity (e.g., relative to the server 120).

Next, at a step 310 shown in FIG. 3, the user interface device 160 sends a signal to, or connects to, the server 120, subsequent to the action of the client device 140 at the step 308. In the present embodiment, the user interface 160 particularly contacts the server 120 to establish the command session, to allow for security command execution, or initiates communication with the client device 140 using the command session (e.g., if the command session is already fully established at the step 308). In the present embodiment, the user interface device 160 is the same device that sent the new command request to the server 120, although in other embodiments the user interface device 160 acting at the step 310 can be a different device than the device which provided the new command request. It should be noted also that, even though the step 310 is described above as involving action by the user interface device 160 relative to the server 120, an arrow corresponding to the step 310 in FIG. 3 is shown to extend both from the user interface device 160 to the server 120 and additionally from the server 120 to the client device 140. This is because, by virtue of the action taken by the user interface 160 at the step 310, communications between the user interface device 160 and client device 140 by way of the command session are established or begun at the step 310.

Notwithstanding the above discussion, in some additional embodiments or circumstances, the user interface device 160 can initiate communication with the client device 140 using the command session at the step 310 by providing a selection of an indicator of the command session between the server 120 and the client device 140. For example, in some embodiments, an indicator (e.g., an icon) regarding a newly-established command session existing between the server 120 and the client device 140 can be graphically displayed on the user interface device 160. With such information being displayed, user input selecting such indication of the command session between the server 120 and the client device 140 can be received at the user interface device 160 (e.g., by way of a touch screen such as the touch screen 218) and, in response to this user input, the user interface device 160 can send a signal to the server 120 that initiates communication with the client device 140. Further, in some embodiments, such an indicator can be graphically displayed on the user interface device 160 along with other indicators concerning a other existing command sessions that connect the server 120 with various ones of the client devices (e.g., with each of the client device 140 and client device 142). Such a set of indicators can be provided in the form of a list or drop-down menu, such that a user selection of a desired command session can be input as a selection from such a list or drop-down menu.

After the user interface device 160 connects to the client device 140 using the command session, or otherwise after communication via the command session has been established or begun, the user interface device 160 can transmit message(s) or command(s) to the server 120, as in a step 312. As represented by a block 309 in FIG. 3, such further communication of message(s) or command(s) (e.g., as a result of the execution of the preceding steps 306, 308, and 10) can be considered proxied. Upon receiving such message(s) or command(s), the server 120 can then forward the message(s) or command(s) to the client device 140 using the command session, as in a step 314.

In the present embodiment, such a message or command being transmitted at the steps 312 and 314 particularly can take the form a security command, in accordance with or in relation to the execution of a SOC task for monitoring or investigation. When the client device 140 receives such a security command, the client device 140 can execute the security command and transmit any result of executing the security command to the server 120 using the command session, as in a step 316. Next, the server 120 can receive the result and forward the result to the user interface device 160, as in a step 318. In some embodiments, executing the security command may not produce a result that is transmitted back to the server 120 and/or the user interface device 160. In still other embodiments, executing the security command can produce a result that is sent back only to the server 120 and is not forwarded to the user interface device 160. Once the security command has been executed and any result has been sent back to the server 120 and/or the user interface device 160, the server 120, the user interface device 160, or the client device 140 can terminate the command session, as in a step 320.

In addition to above description, it should be appreciated that at least some embodiments encompassed herein particularly achieve access-controlled communications, as represented by a block 311 of FIG. 3. More particularly, in some such embodiments, the user interface device 160 can send access credentials to the server 120 when requesting to communicate with the client device 140 and/or when sending the security command to the server 120. The server 120 can determine whether the access credentials received from the user interface device 160 allow access to the client device 140 and/or whether the access credentials allow the user interface device 160 to transmit the specific security command to the client device 140. When the access credentials allow access to the client device 140, the server 120 can forward the security command to the client device 140 using the command session and when the access credentials do not allow access to the client device 140, the server 120 can refrain from forwarding the security command to the client device 140 using the command session. When the access credentials allow the user interface device 160 to transmit the specific security command to the client device 140, the server 120 can forward the specific security command to the client device 140 using the command session and, when the access credentials do not allow the user interface device 160 to transmit the security command to the client device 140, the server 120 can refrain from forwarding the security command to the client device 140 using the command session.

Allowing the server to check the access credentials at one or both of the general device level and/or at the level of the contents of the specific security command increases options and general security robustness. For example, a first level of user access for the client device 140 may be configured to be only able to send some security commands to the client device, such as a command for the client device 140 to record some or all of the client device's operations and transmit a record of those operations to the server 120 and/or the user interface device 160 and not to send commands to deactivate the client device 140. A second level of user access to the client device may be able to send any command to the client device 140, including deactivating the client device 140.

Also as represented by the block 311 of FIG. 3, in some embodiments, the server 120 can audit any communications between the user interface device 160 and the client device 140. For example, in some embodiments, the server can monitor the communication, such as the security command, between the user interface device 160 and the client device 140 over the command session and can save a record of the communication, the security command, and any result of the security command to a memory device of the server.

In view of the above discussion, it should be appreciated that one or more advantages can be achieved by way of embodiments disclosed or encompassed herein. For example, at least some embodiments encompassed herein make it possible to achieve a real-time two-way communication channel to connect a client device (e.g., operating as an agent) with a server. Further, at least some embodiments encompassed herein make it possible to achieve on-demand websocket communications, by way of which it is possible to avoid unnecessary connection overhead on the server and possible to enforce access control and auditing. Thus, at least some embodiments encompassed herein provide procedures allowing for enhanced monitoring, governing, or enforcing interactions with client devices.

Also, in at least some embodiments encompassed herein, a server is able to pass messages between two real-time channels, e.g., one between the server and a client device (or agent), and another between the server and a user interface device. In some such embodiments, before sending a message from a SOC user (at the user interface device) to the agent, the server can verify if the user has permission to send the specific message, and also can operate in a manner such that all of the data sent to and/or from the agent will be logged in the server for future reference. At the same time, notwithstanding any of the above discussion or description concerning the providing of security, it should be appreciated that no system or method is absolutely secure, and nothing described herein should be understood as providing any guaranty of any particular level of security; rather, to achieve any particular level of security, any one or more other provisions can be made in addition to any methods or systems described herein.

Additionally, the present disclosure includes and encompasses numerous other embodiments, implementations, and applications of systems, in addition to those described above. Although the present disclosure envisions embodiments and applications that employ computer systems acting in accordance with a client-server model, the present disclosure is also intended to encompass other arrangements (e.g., peer-to-peer computer system or cloud system arrangements). Additionally, although the present disclosure describes embodiments relating to a security operations center, the present disclosure is also intended to be applicable to other embodiments, applications, or environments. Further for example, the logic flows described above do not require the particular order described or sequential order to achieve desirable results. Other steps may be provided, steps may be eliminated from the described flows, and other components may be added to or removed from the described systems. Other embodiments may be within the scope of the present disclosure.

While the principles of the invention have been described above in connection with specific apparatus and method, it is to be clearly understood that this description is made only by way of example and not as a limitation on the scope of the invention. It is specifically intended that the present invention not be limited to the embodiments and illustrations contained herein, but include modified forms of those embodiments including portions of the embodiments and combinations of elements of different embodiments as come within the scope of the following claims.

What is claimed is:

1. A method comprising:
directing a client device to periodically check a server for a new command request for the client device, by way of an agent application installed on a client device;
downloading, at the client device, a new command request for the client device from the server; and
executing the new command request at the client device.

2. The method of claim 1, further comprising:
the new command request directing the client device to set up a command session between the server and the client device transparently from a user of the client device; and
responsive to executing the new command request, the client device setting up the command session with the server transparently from the user of the client device.

3. The method of claim 2, further comprising:
a user interface device of the server adding the new command to the server;
the user interface device transmitting a security command to the server;
the server forwarding the security command to the client device using the command session; and
the client device transmitting a result of executing the security command to the server using the command session; and
the server forwarding the result to the user interface device.

4. The method of claim 3 further comprising:
the user interface device receiving a selection of an indicator of the command session between the server and the client device; and
responsive to the selection, the server forwarding the security command to the client device using the command session.

5. The method of claim 3, further comprising, responsive to receiving the result, terminating the command session.

6. The method of claim 3, further comprising:
the server determining whether access credentials received from the user interface device allow access to the client device;
when the access credentials allow access to the client device, the server forwarding the security command to the client device using the command session; and
when the access credentials do not allow access to the client device, the server refraining from forwarding the security command to the client device using the command session.

7. The method of claim 3 further comprising:
the server determining whether access credentials received from the user interface device allow the user interface device to transmit the security command to the client device;
when the access credentials allow the user interface device to transmit the security command to the client device, the server forwarding the security command to the client device using the command session; and
when the access credentials do not allow the user interface device to transmit the security command to the client device, the server refraining from forwarding the security command to the client device using the command session.

8. The method of claim 3, further comprising:
the server monitoring communication between the user interface device and the client device over the command session; and
the server saving a record of the communication, the security command, and the result to a memory device of the server.

9. The method of claim 3 wherein the user interface device includes a remote terminal connected to the server via a wireless or wired two way communication channel.

10. The method of claim 1, further comprising:
the agent application opening a universal runtime environment on the client device for executing the new command request transparently from a user of the client device,
wherein the new command request includes security command instructions to record some or all operations of the client device, disable some or all of the operations of the client device, or transmit a record of some or all of the operations of the client device to the server.

11. A system comprising:
a client device; and
a server,
wherein, an agent application installed on the client device directs the client device to periodically check the server for a new command request for the client device, and
wherein the client device downloads the new command request for the client device from the server and executes the new command request.

12. The system of claim 11, wherein the new command request directs the client device to set up a command session between the server and the client device transparently from a user of the client device, and
wherein, responsive to executing the new command request, the client device sets up the command session with the server transparently from the user of the client device.
wherein a user interface device of the server adds the new command to the server,
wherein the user interface device transmits a security command to the server,
wherein the server forwards the security command to the client device using the command session,
wherein the client device transmits a result of executing the security command to the server using the command session, and
wherein the server forwards the result to the user interface device.

13. The system of claim 12 wherein the user interface device receives a selection of an indicator of the command session between the server and the client device, and
wherein, responsive to the selection of the indicator of the command session between the server and the client device, the server forwards the security command to the client device using the command session.

14. The system of claim 12, wherein, responsive to receiving the result, the user interface device terminates the command session.

15. The system of claim 12, wherein the server determines whether access credentials associated with the user interface device allow access to the client device,
wherein, when the access credentials allow access to the client device, the server forwards the security command to the client device using the command session, and
wherein, when the access credentials do not allow access to the client device, the server refrains from forwarding the security command to the client device using the command session.

16. The system of claim 12, wherein the server determines whether access credentials associated with the user interface device allow the user interface device to transmit the security command to the client device,
wherein, when the access credentials allow the user interface device to transmit the security command to the client device, the server forwards the security command to the client device using the command session, and
wherein, when the access credentials do not allow the user interface device to transmit the security command to the client device, the server refrains from forwarding the security command to the client device using the command session.

17. The system of claim 12, wherein the server monitors communication between the user interface device and the client device, and saves a record of the communication, the security command, and the result to a memory device of the server.

18. The system of claim 12 wherein the user interface device includes a remote terminal connected to the server via a wireless or wired two way communication channel.

19. The system of claim 11, wherein the agent application opens a universal runtime environment on the client device for executing the new command request transparently from a user of the client device,
wherein the new command request includes security command instructions to record some or all operations of the client device, disabling some or all of the operations of the client device, or transmitting a record of some or all of the operations of the client device to the server.

20. A method comprising:
a server storing a new command for a client device;
the server receiving a request for the new command from the client device;
responsive to the request, the server transmitting the new command to the client device;
responsive to transmitting the new command to the client device, the server receiving access to a command session with the client device;
the server receiving access credentials, a selection of an indicator of the command session, and a security command from a user interface device;
responsive to the selection of the indicator of the command session and the server determining that the access credentials allow the user interface device to access the client device, the server forwarding the security command to the client device using the command session;
the server receiving a result of the security command from the client device;
the server forwarding the result of the security command to the user interface device; and
the server terminating the command session.
